(19) United States
(12) Patent Application Publication
(10) Pub. No.: US 2005/0135301 A1
(43) Pub. Date: Jun. 23, 2005

(54) Automatic configuration of services in a communication system

(76) Inventors: Erkko Lehtonen, Tampere (FI); Jouni Smolander, Tampere (FI)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/045,092

(22) Filed: Jan. 31, 2005

Related U.S. Application Data
(63) Continuation of application No. 09/416,526, filed on Oct. 12, 1999, now abandoned.

(30) Foreign Application Priority Data
Oct. 12, 1998 (GB) 9822162.5

(51) Int. Cl. H04Q 7/00

(52) U.S. Cl. 370/328

(57) ABSTRACT

A method and apparatus is disclosed which allows for automatic configuration of communications services within a communication system dependent upon certain pre-defined criteria and external parameters.

### BACKGROUND OF THE INVENTION

This invention relates to a method for automatically configuring communication services for a communication system.

In this context, communications services comprise options provided by the service provider, such as Call Hold, Call Waiting, Call Forwarding, or Call Barring. In addition, services specifically related to text messages (SMS) and data calls may be provided.

The Global System for Mobile Communications (GSM) defines the use of Multiple Subscriber Profiles (MSP), whereby the subscriber may define up to four different profiles. Each profile is defined as a set of communication services. The profile is chosen by the subscriber and/or the service provider.

The use of profiles further allows the subscriber to separate his telecommunication service needs into different categories e.g. personal and business. The relevant GSM Technical Specification is GSM 02.97 (Stage 1 Description of MSP service).

MSP is an optional service allowing subscribers to associate several profiles with a single Subscriber Identity Module (SIM), and a single International Mobile Subscriber Identity (IMSI), with each profile being a subscription option. Each profile may be used with Mobile Originated (MO) calls and Mobile Terminated (MT) calls.

Any charges accrued with a profile are billed under that profile, allowing the subscriber to customise how he is charged for use of the telephone service.

The subscriber may or may not be the user of the service. For instance, the subscriber may be an employer, and the user may be an employee of the subscriber to whom a phone has been issued for work use. The employer may wish to provide a profile to the employee so that he may make personal calls using that profile, and be charged accordingly. It is possible, of course, that the subscriber and the user are the same person, as will be so for the majority of domestic subscribers. However, in the business arena of use, the user will generally not be the subscriber.

Individual profiles may be selected on a call-by-call basis, or one may be registered. The registered profile will be used for all speech calls, data calls and Short Message Service (SMS) transmissions unless another profile is explicitly selected prior to placing a call, or using the SMS service. Throughout this specification, references to making or receiving a ‘call’ shall include making or receiving a speech or data call, and respectively sending or receiving an SMS message.

Up to four profiles may be provided, and hence selected, but only one of them can be registered. Registration may be performed by the subscriber or the service provider. Note that in certain cases, the network operator, i.e. the owner and maintainer of the infrastructure, may be the same organisation as the service provider, i.e. the organisation which sells airtime contracts and provides a telecommunication service to the subscriber. Any reference herein to service provider is intended to include network operator if appropriate.

Registration of profiles is managed by the Home Location Register (HLR) of the currently selected network. Selection of profiles can be managed at the Visitors Location Register (VLR) only, as this is done on a per-call basis, and does not affect the registered profile held at the HLR.

All MO calls are handled according to the selected profile. The selected profile is the registered profile unless another is explicitly selected.

The GSM standard specifies that a profile may be selected by keying on the keypad, *59n# DN SEND, where n is the identity of the profile to be selected, and DN is the number to be called.

In order to register a profile, a similar process is followed. The code to be transmitted is *59n# SEND i.e. no called number is included. This specifies to the network that this instruction is a registration rather that a selection process.

The user may interrogate the network to determine which profile is currently registered. In GSM systems, this is accomplished by typing *#59# SEND on the MS. The network responds with the currently registered profile.

For MT calls, the profile is selected by association with the Mobile Station ISDN number (MSISDN) addressed. Each profile has a unique MSISDN. i.e. MSISDN #1 is associated with profile #1.

The profile registration process, according to the prior art, is illustrated at FIG. 1 of the attached drawings. The process is assumed to begin with the MS in the IDLE state 100. It shows that when an attempt is made to register a profile 110 from the idle state, the network checks to ensure that the MSP option is provisioned 120. If it is not, then an error is reported 140, 170 and the phone returns to the idle state 180 with the same profile as before. If MSP is provisioned, a further check is made to ensure that the chosen profile is provisioned 130. If it is not, then an error is reported 160, 170 and the phone returns to the idle state 180 with the same profile as before. If the chosen profile is provisioned, then the new profile is registered with the Home Location Register (HLR) 150, and the user is informed 170 before the phone returns to the idle state 180.

If MSP is not provisioned, then the profile used for a subscriber is termed the default profile. This can only be configured by the service provider, and the subscriber has no control over its characteristics.

This profile registration process can only take place with explicit instructions from the service provider or the subscriber.

The GSM 02.97 Specification gives no implementation details as to how a profile is registered by the service provider. A disadvantage of the prior art system of registration is that one profile forms the registered profile for all circumstances, and will be used for all calls unless another profile is explicitly chosen through selection or registration.

Consequently, the user of the MS must ensure that the correct profile is registered before he makes use of the services of the communications network. This reliance on manual intervention can lead to the incorrect profile being used for a given situation, as well as being inconvenient for the user.

### SUMMARY OF THE INVENTION

According to a first aspect of the present invention, there is provided a method of automatically configuring communication services for a subscriber within a communication system, comprising the steps of sensing an external parameter; choosing for the particular subscriber, a configuration of communication services from a plurality of configurations; and using the chosen configuration in respect of the subscriber, wherein said choosing is performed in dependence on a pre-defined criterion and the sensed external parameter.

In GSM systems, each of the plurality of configurations may be a defined profile forming part of an MSP service.

Preferably, the subscriber may be able to define his own profile configuration and/or automatic registration criteria.

The external parameter may be any measurable variable outside the communication system. In preferred embodiments, external parameters which may be sensed include, but are not limited to environmental parameters such as date, time or MS location. In another embodiment, external parameters, including hardware parameters such as equipment identity, may be sensed. In a further embodiment external parameters may include type of call (e.g. speech, data or SMS).

The pre-defined criterion may be defined in terms of one or more of the above parameters.

Preferably, in GSM systems, using the configuration for the subscriber corresponds to registering a profile with the HLR.

The invention could equally be used in other telecommunication standards employing multiple subscriber profiles, such as Universal Mobile Telecommunication Standard (UMTS). UMTS may implement a scheme whereby a single subscriber identity (USIM) is associated with a single profile, and implementation of an MSP type service will require several USIMs per MS.

Preferably, the configurations are prioritised such that one of higher priority is always used before one of lower priority, provided that the criterion is met in each case.

One profile may be designated to be registered in the event that none of the profiles meet any of the criteria.

Certain configurations may be advantageously barred from use according to rules set up either by the subscriber or the service provider.

As applied to GSM systems, such configurations are here termed forbidden profiles. Advantageously, forbidden profiles allow the subscriber to exercise greater control over service usage, especially when the subscriber is a e.g. an employer, and the user of the service is e.g. an employee.

The present invention offers an advantage in that the subscriber will generally find himself operating with the appropriate profile for a given set of circumstances, and hence the need to manually register a new profile, with the associated inconvenience, and possibility of error is minimised.

According to a second aspect of the present invention, there is provided an apparatus, for use in a communication system, comprising a register of subscribers to the communication system; a register of alternative configurations; sensing means for sensing an external parameter; means for choosing one of the alternative configurations in response to said sensing means and a predefined criterion; and means for using the chosen configuration in respect of a particular subscriber.

Preferably, the register of subscribers is contained in an HLR of a GSM system.

Preferably, the register of alternative configurations is associated with the subscriber.

Preferably, the pre-defined criterion is associated with the subscriber.

### BRIEF DESCRIPTION OF THE DRAWINGS

For a better understanding of the present invention, and to understand how the same may be brought into effect, reference will now be made to the appended drawings in which:

FIG. 1 shows the prior art profile registration process according to GSM 02.97;

FIG. 2 shows the automatic profile registration process according to the present invention;

FIG. 3 shows how the manual registration process is modified to include checks for an attempt to register a forbidden profile;

FIG. 4a shows the communication paths in a communications network of the invention; and

FIG. 4b shows part of the internal structure of the HLR.

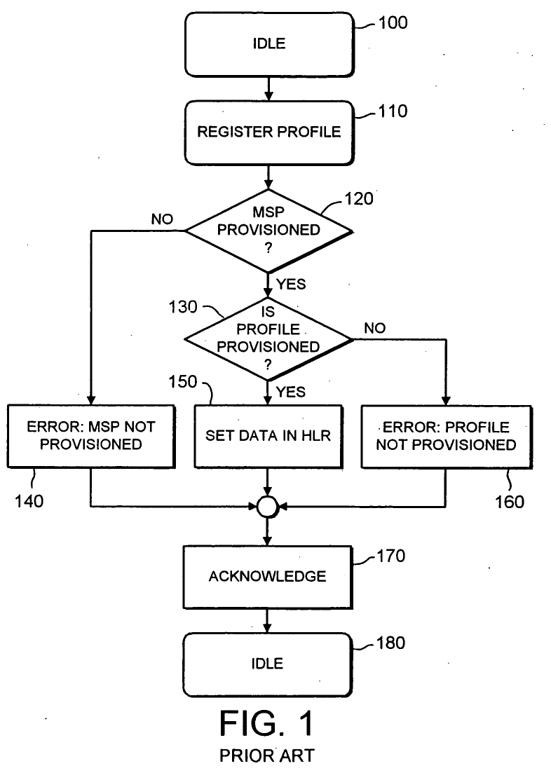

### DETAILED DESCRIPTION

Embodiments of the present invention allow a different profile to be registered according to particular rules or criteria, defined in terms of parameters, including external parameters. A criterion may be time dependent. For example, a first profile may be registered between the hours of 9 am and 5 pm, Monday to Friday, and all calls made with that profile will be classed as business calls, and billed accordingly. Outside those time limits, a second profile may be registered, and all calls made with that profile will be classed as personal calls, and billed accordingly. A criterion may depend upon MS location. For example, a subscriber may regularly travel to another country, and he may wish to set up a profile which is automatically registered as soon as he connects to the foreign network. Also, if the MS makes a call from a designated cell-site, a more favourable tariff may be applied by the service provider. A further criterion which may be used to determine which profile should be registered is the telephone number called from the MS. This would allow, for instance, all calls to one or more specified numbers to be made with a chosen profile which may have special billing arrangements.

The profile registration criteria are checked each time an MS connects to a network, and this forms part of the MS registration procedure along with the regular GSM activities of authentication and encryption. The registration criteria are re-evaluated by comparing the criteria against the parameter or parameters specified by the criteria, each time the MS makes a new call. The parameters are compared at the HLR against the profile registration criteria to determine whether a new profile should be registered in response to a change in the specified parameters. For example, if the profile is required to change from ‘business’ to ‘personal’ at 5 pm on weekdays, then at call set-up, the HLR will check the registration criteria against the time, and make any necessary changes to the registered profile.

MSP is an optional service provided by the service provider, and when subscribing to this option, the subscriber can specify which services are to be associated with each profile. According to embodiments of the present invention, the subscriber can also specify the criteria which are to be used for automatic profile registration. An example specification might be as shown in the tables below:

TABLE 1a

| Profile # | Service Configuration |
|---|---|
| 1 | Speech, SMS, BOIC-exHC |
| 2 | Speech, SMS, 9.6 Kbit/s non-transparent data |
| 3 | HSCSD, GPRS, Fax |
| 4 | BAOC |

TABLE 1b

| Automatic Registration Criteria | Profile # |
|---|---|
| Monday-Friday AND Home Network | 1 |
| Cell ID = AB1 | 1 |
| Saturday and Sunday AND Home Network | 2 |
| Type of Call = DATA | 3 |
| Equipment = Nokia ® Communicator AND | 3 |
| Number Called = 0345 67890 | |
| Any day AND Non-Home Network | 4 |

The above tables shows how the subscriber might wish to organise his services depending on which profile is in use at any given time.

Table 1a shows how various service configurations may be defined for each profile. Table 1b specifies the criteria which are used to automatically register the appropriate profile.

Profile #1 provides for speech services, SMS messaging and Barring Of outgoing International Calls except those to the Home Country (BOIC-exHC). This profile will be automatically registered according to the criteria specified in Table 1b. In this case, profile #1 will be used Monday to Friday on the home network, or if the ID of the cell in which the mobile is situated corresponds to AB1.

Profile #2 provides for speech services, SMS messaging and data service specified at 9.6 Kbit/s non-transparent. The criteria for which this profile will be automatically registered can be found in Table 1b i.e. Saturday and Sunday when connected to the home network.

Profile #3 provides for High Speed Circuit Switched Data (HSCSD), General Packet Radio Services (GPRS) and Fax services. This profile will be automatically registered if the type of call is Data, or if the International Mobile Equipment Identity (IMEI) corresponds to a Nokia® Communicator and a certain number is called.

Profile #4 provides for Barring of All Outgoing Calls (BAOC), where only emergency (112 or 999) calls may be made, and incoming calls can be received. The criteria for which this profile will be automatically registered is when the MS is roaming i.e. not on the home network.

Table 1b shows how more than one criterion may be defined to automatically register a given profile. If this is the case, the relevant profile will be registered if any one of the alternative criteria evaluates positive.

There is no limit to the logical combinations which can be defined, and all the normal logical operators (e.g. AND, OR, NOT) may be used to define the criteria.

It may be useful to provision certain services, e.g. Call Waiting, across all profiles to avoid user confusion when switching between profiles.

In an alternative embodiment, profiles and/or automatic registration criteria may be defined by the service provider, with the subscriber being able to choose his particular configuration from those offered.

It is apparent that there may be overlap between the criteria, and to ensure that no conflicts arise, it may be necessary to either prioritise the profiles i.e. profile #4 is always registered ahead of profile #3, 2 or 1 even if the criteria are satisfied in more than one instance, or prioritise the individual criteria e.g. time of day always takes precedence over location or equipment identity.

It is also possible to envisage a situation where none of the registration criteria are met. If this happens, the previously registered profile will be used, or one profile may be designated to be registered anyway. This may not be the same as the defined default profile which is used if MSP is not provisioned.

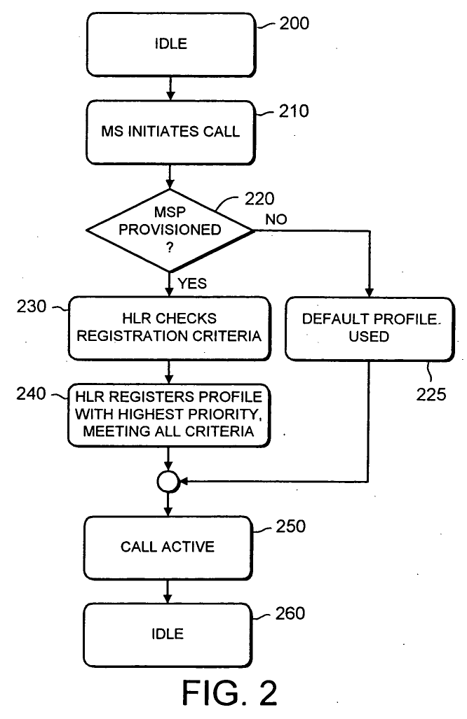

The automatic registration process in response to making a call is shown in flowchart form in FIG. 2. This shows the MS initially in the IDLE state 200. When the MS initiates a call 210, the HLR checks that MSP is provisioned 220. If it is not, then the default profile, defined by the service provider, is used 225. If MSP is provisioned, then the HLR determines the appropriate profile 230 by evaluating the pre-defined rules or criteria. To evaluate the rules or criteria, the HLR refers to the register of alternative profiles for the calling subscriber, and then senses or receives the individual parameters specified in the criteria. For instance the parameters upon which profile registration depend may include, but are not limited to external parameters such as time, date, equipment identity, MS location and type of call. The values of the parameters are compared to the requirements of the criteria, and the profile having the highest priority of those that evaluate positive against the criteria is registered 240.

With the profile registered, the call proceeds in the normal way 250. After the call is terminated, the MS returns to the IDLE state 260.

It may be desirable to block certain profiles from being used according to certain criteria. Such profiles are here termed forbidden profiles. Two scenarios exist where profiles may be forbidden:
1. Registration may be forbidden.
2. Selection may be forbidden on a call-by-call basis.

The use of the forbidden profile allows the subscriber to control access to different profiles. For example, the ‘business’ profile may be automatically registered during normal working hours, and all calls made with that profile are paid for by the employer/subscriber, whereas all calls outside those hours are made with the ‘personal’ profile automatically registered, and are paid for by the employee/user. In this example, the business profile is forbidden outside the time limits set by the subscriber. Any attempt to manually register or select the ‘business’ profile outside the specified time limits will result in the user being informed of an error, the registered profile will not alter and neither will the user be able to select the requested profile.

The subscriber can thus limit the user's access to profiles according to rules which he defines with the service provider.

The automatic registration process may not register a profile which is forbidden. The forbidden profile is primarily intended to prevent the user from manually selecting or registering a profile whose use is barred according to certain rules.

Additionally, the service provider may wish to block access to certain profiles, and he too is able to declare one or more profiles forbidden.

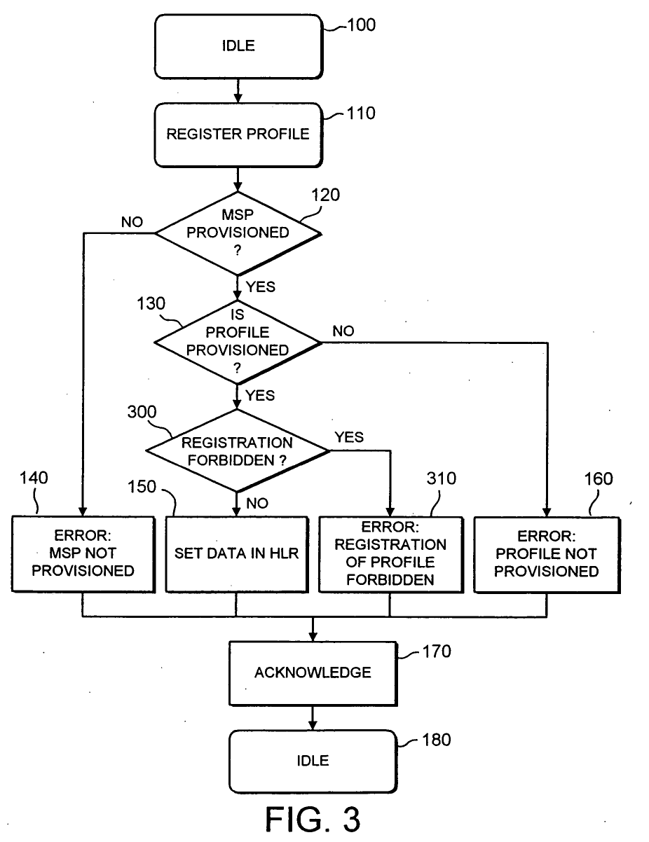

The flowchart of FIG. 3 shows how the registration process is altered by the addition of the forbidden profile option. The process begins with the MS in the IDLE state 100. An attempt is made to register a new profile 110. A check is then made to ensure that the MSP service is provisioned 120. If not, an error is reported 140, 170 and the phone returns to the idle state 180. If MSP is provisioned, a further check is made to ensure that the chosen profile is provisioned 130. If it is not, then an error is reported 160, 170, and the phone returns to the idle state 180. If the chosen profile is provisioned, then a check is made to ensure that registration of that profile is not forbidden 300. If it is, an error is reported 310, 170 and the phone returns to the idle state 180. If registration of the profile is permitted, then the new profile is registered with the HLR 150, and the user is informed 170 before the phone returns to the idle state 180.

In the above process, any step which leads to an error 140, 150, 160, will maintain the registration of the previously registered profile.

With only minor modifications, the flowchart of FIG. 3 applies equally to attempts to select, rather than register, a forbidden profile. Selection of profiles is managed by a VLR if the MS is away from the service area of the HLR. If this is the case, then step 150 would comprise setting the data in the VLR for the duration of that call only.

The HLR holds a register of the subscribers to the communication service. Each subscriber will have an individual record comprising, amongst other data, information relating to whether MSP has been provisioned, how the profiles have been defined, automatic registration criteria, and forbidden profiles, if any.

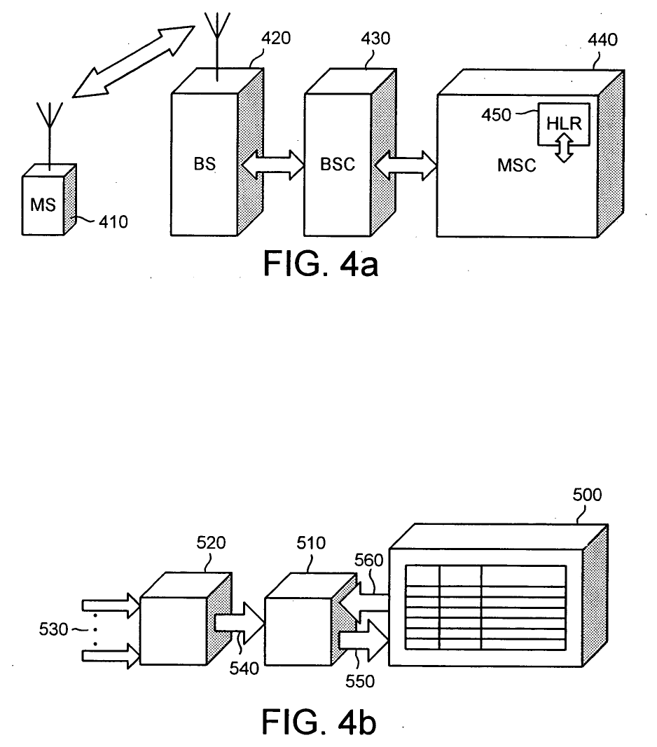

FIG. 4a shows the configuration of a typical communications network according to an embodiment of the present invention. The HLR 450 forms part of the Mobile Services Switching Centre (MSC) 440. Communication between the MSC 440 and the MS 410 is effected via a Base Station Controller (BSC) 430, and a Base Station (BS) 420.

The communication paths between the various elements of the network are indicated by arrows.

FIG. 4b shows part of the internal structure of the HLR of FIG. 4a. Depicted is the register 500 which stores subscriber data, including details of MSP provision, automatic registration criteria and forbidden profiles. The HLR needs the values of parameters 530 to evaluate the criteria stored in the register 500. The HLR is able to sense any external parameters 530 needed. Sensing means 520 are provided to read the defined parameters 530. For instance, one of the external parameters may be date or time, and the HLR will be able to evaluate this via a real-time clock. Another external parameter may be equipment identity or MS location. Both of these variables are transmitted to the network by the MS at least at subscriber registration to the network. Again the sensing means 520 is sensitive to this information. Processor 510 reads data 540 from the sensing means 520, and 560 from the register 500 regarding the automatic profile registration criteria, and chooses a profile according to the criteria defined in the register 500 and the measured parameters 530. As a result of this process, the new profile is registered by writing 550 this information into the register 500.

In view of the foregoing description it will be evident to a person skilled in the art that various modifications may be made within the scope of the invention.

The present invention includes any novel feature or combination of features disclosed herein either explicitly or any generalisation thereof irrespective of whether or not it relates to the claimed invention or mitigates any or all of the problems addressed.

1. A method of configuring communication services for a subscriber within a communication system, comprising:
defining a set of profiles for the subscriber, each profile defining a set of communication services from amongst a plurality of communication services available within the communication system;
choosing a particular one of said set of profiles automatically in dependence on a pre-defined criterion definable by the subscriber or a service provider of the communication system; and
registering the chosen profile as the profile used to define a current configuration of communication services available to the subscriber,
wherein said predefined criterion defines a condition under which said particular one of said set of profiles is to be registered as the profile used to define the current configuration of communication services available to the subscriber.

2. A method as claimed in claim 1, wherein said set of profiles is specific to the subscriber.

3. A method as claimed in claim 1, wherein the pre-defined criterion is specific to the subscriber.

4. A method as claimed in claim 1, comprising checking the choice of registered profile each time a call is made.

5. A method as claimed in claim 1, wherein the set of profiles is ranked in order of priority such that one of relatively higher priority which satisfies the predefined criterion is used before one of relatively lower priority which also satisfies the predefined criterion.

6. A method as claimed in claim 1, wherein a predetermined profile is designated to be registered in the event that none of said set of profiles meets the pre-defined criterion.

7. A method as claimed in claim 1, wherein the automatic choosing of a profile may be overridden to allow selection or registration of a particular one of said set of profiles.

8. A method as claimed in claim 7, wherein selection or registration of a certain profile is not permitted according to a predefined rule.

9. A method as claimed in claim 1, wherein said set of profiles is stored in a central database of the communication system.

10. A method as claimed in claim 9, wherein the central database is a Home Location Register of a GSM system.

11. A method as claimed in claim 1, wherein the predefined criterion is a date-dependent criterion and choosing a particular one of said set of profiles is performed automatically in dependence on said date-dependent criterion.

12. A method as claimed in claim 1, wherein the predefined criterion is a time-dependent criterion and choosing a particular one of said set of profiles is performed automatically in dependence said time-dependent criterion.

13. A method as claimed in claim 1, wherein the predefined criterion is a location-dependent criterion and choosing a particular one of said set of profiles is performed automatically in dependence on said location-dependent criterion.

14. A method as claimed in claim 1, wherein the predefined criterion is dependent upon the equipment identity of the mobile station.

15. A method as claimed in claim 1, wherein the predefined criterion is dependent upon the number called.

16. A method as claimed in claim 1, wherein the predefined criterion is dependent upon the type of call made.

17. A method as claimed in claim 1, wherein said particular one of said set of profiles is chosen automatically according to a plurality of predefined criteria.

18. An apparatus, for use in a communication system, comprising:
a register containing information about a subscriber to the communication system;
a register comprising a set of profiles for the subscriber, each profile defining a set of communication services from amongst a plurality of communication services available within the communication system;
means for choosing a particular one of said set of profiles automatically in dependence on a predetermined criterion definable by the subscriber or a service provider of the communication system; and
means for registering the chosen profile as the profile used to define a current configuration of communication services available to the subscriber,
wherein said predefined criterion defines a condition under which said particular one of said set of profiles is to be registered as the profile used to define the current configuration of communications services available to the subscriber.

19. An apparatus as claimed in claim 18, wherein said registers form part of the Home Location register of a GSM communication system.

20. An apparatus as claimed in claim 18, wherein said set of profiles is specific to the subscriber.

21. An apparatus as claimed in claim 18, wherein the pre-defined criterion is specific to the particular subscriber.

22. The method according to claim 18, further comprising specifying the plurality of communication services by the subscriber.

23. The method according to claim 18, wherein the plurality of communication services further comprise at least one of speech services, SMS messaging, international calls barred, international calls barred except to home country, data transfer rate, fax services, High Speed Circuit Switched Data (HSCSD), General Packet Radio Services (GPRS), and outgoing calls barred.

24. The method according to claim 18, wherein the predetermined criterion comprise at least one of day of the week, cell identification, location, type of call, number called, and equipment.

25. A method as claimed in claim 1, wherein a configuration of communication services chosen automatically is registered for use as a default configuration and is used to define the current configuration of communication services available to the subscriber unless another configuration of communication services is explicitly selected.

26. A method as claimed in claim 8, wherein the predefined rule is set up by the subscriber or the service provider of the communication network.

27. A method as claimed in claim 8, wherein if an attempt is made to override a profile chosen automatically to select or register a particular profile different from the profile chosen automatically, a check is performed to determine if selection or registration of said particular profile is forbidden, whereupon if selection or registration of said particular profile is forbidden, its selection or registration is prevented.

28. A method as claimed in claim 13, wherein the predefined criterion is indicative of a cell of the communication system in which a mobile station of the subscriber is located.

29. A method according to claim 1, wherein the subscriber defines at least one configuration of communication services for a user of a mobile station other than the subscriber and defines at least one predefined criterion relating to selection of said at least one configuration by said user.

30. An apparatus as claimed in claim 18, wherein said means for automatically choosing one of the set of profiles is arranged to perform said choosing each time a call is made.

31. An apparatus as claimed in claim 18, wherein said means for automatically choosing one of the set of profiles is arranged to register an automatically chosen configuration as a default configuration that defines the current configuration of communication services available to the subscriber if no other configuration of communication services is explicitly selected.

32. An apparatus as claimed in claim 18, wherein said means for automatically choosing one of the set of profiles is arranged to choose a predetermined configuration of communication services in the event that no configurations meet the predefined criterion.

33. An apparatus as claimed in claim 18, comprising means for overriding the automatic choosing of a profile to allow selection or registration of a particular profile from said set of profiles.

34. An apparatus as claimed in claim 33, arranged to prevent overriding of the automatic choosing of a profile.

35. An apparatus as claimed in claim 34, comprising means for performing a check in the event that an attempt is made to override the automatic choosing of a profile to select or register a different profile from the one particular profile chosen automatically to determine if selection or registration of said particular profile is forbidden, whereupon if selection or registration of said particular profile is forbidden, said apparatus is arranged to prevent its selection or registration.

36. An apparatus as claimed in claim 18, wherein said choosing one of the set of profiles includes comparing an indication of a date with a date-dependent criterion and choosing a profile based on the result of said comparison.

37. An apparatus as claimed in claim 18, wherein said choosing one of the set of profiles includes comparing an indication of a time with a time-dependent criterion and choosing a profile based on the result of said comparison.

38. An apparatus as claimed in claim 18, wherein said choosing one of the set of profiles includes comparing an indication of a location of a mobile station with a location-dependent criterion and choosing a profile based on the result of said comparison.

39. An apparatus as claimed in claim 38, wherein the predetermined criterion is indicative of a cell of the communication system in which the mobile station is located.

40. An apparatus as claimed in claim 18, wherein said choosing one of the set of profiles includes comparing an indication of an equipment identity of a mobile station with an equipment identity-dependent criterion and choosing a profile based on the result of said comparison.

41. An apparatus as claimed in claim 18, wherein said choosing one of the set of profiles includes comparing an indication of a number called with a number-dependent criterion and choosing a profile based on the result of said comparison.

42. An apparatus as claimed in claim 18, wherein said choosing one of the set of profiles includes comparing an indication of a type of call with a call type-dependent criterion and choosing a profile based on the result of said comparison.

43. A method of automatically configuring communication services for a subscriber within a communication system, comprising:
sensing an external parameter;
determining if the sensed external parameter relates to any forbidden configurations of communication services;
choosing for the particular subscriber, a configuration of communication services not forbidden from a plurality of configurations, the choosing being performed automatically in dependence on the sensed external parameter meeting a predefined criterion; and
using the chosen configuration in respect of the subscriber.
